(19) United States
(12) Patent Application Publication
(10) Pub. No.: US 2026/0171858 A1
(43) Pub. Date: Jun. 18, 2026

(54) 4-PHASE GENERATOR AND ECCENTRIC MASS LOAD SUBSYSTEMS WITH 4-PHASE ECCENTRIC MASS LOAD SYSTEMS

(71) Applicants: Thomas Navarro, Wheat Ridge, CO (US); Zachary J. Navarro, West Minister, CO (US); Tiffany J. Navarro, Denver, CO (US)

(72) Inventors: Thomas Navarro, Wheat Ridge, CO (US); Zachary J. Navarro, West Minister, CO (US); Tiffany J. Navarro, Denver, CO (US)

(21) Appl. No.: 19/429,966

(22) Filed: Dec. 22, 2025

Related U.S. Application Data
(63) Continuation-in-part of application No. 18/301,764, filed on Apr. 17, 2023, now Pat. No. 12,512,726.
(60) Provisional application No. 63/419,373, filed on Oct. 26, 2022.

(51) Int. Cl. H02K 1/16; H02K 11/30; H02K 19/10

(52) U.S. Cl. CPC H02K 1/16; H02K 11/30; H02K 19/10

(57) ABSTRACT

The disclosure relates to a novel four-phase motor and generator device with increased efficiency for generating electrical energy. The device features a stator wall with four stator slots and four pole groups, and an armature rotatable within the stator wall. The four stator slots are divided into four pole groups of opposing stator slots; the two opposing stator slots include a N (North) stator slot and an S (South) stator slot. N and S (South) stator slots are alternatively activated in response to rotation of the armature. The activation of the armature pole groups results in armatures rotating magnetic field within the stator wall, and only four poles are actively coupled in any given configuration. The invention also includes a method of operating the motor for generating electrical energy with increased efficiency and an environmentally friendly manner compared to conventional motors.

### CROSS-REFERENCE TO RELATED APPLICATIONS

The present application is a Continuation-in-Part of co-pending U.S. Utility Application No. Ser. No. 18/301,764, filed Apr. 17, 2023, which in turn claims priority to, and the benefit of, U.S. Provisional Application No. 63/419,373, filed on Oct. 26, 2022, and is incorporated herein by reference in its entirety.

### FIELD OF THE INVENTION

The present disclosure relates generally to electric generators and, more particularly, to a four-phase alternating current (“AC”) generator and eccentric mass load subsystems. In one embodiment, the device includes a stator wall with four stator slots and four pole groups for generating electrical energy with increased efficiency compared to conventional generators. Accordingly, the present disclosure makes specific reference thereto. Nonetheless, it is appreciated that aspects of the present disclosure are also equally applicable to other like applications, devices, and methods of manufacture.

### BACKGROUND

Electric power consumption is essential to modern life, providing energy for lighting, heating, cooling, and refrigeration and for operating appliances, computers, electronics, machinery, and public transportation systems and more. However, increased electric power consumption can adversely impact the environment and ultimately lead to global warming. Large volumes of CO² emissions from worldwide electricity use have contributed significantly to serious environmental challenges such as global warming. Reducing electricity consumption can lower costs, enhance energy security, and decrease pollution from non-renewable energy sources.

GenerallyGenerally, all parts of the electricity system can affect the environment, and the size of these impacts will depend on how and where the electricity is generated and delivered. Electricity generation can generate solid waste, which may include hazardous waste and emissions of greenhouse gases and other air pollutants that affect the atmosphere. Conventional single, 2-phase, and 3-phase generators use considerable power and are ineffective at generating electricity. Single phase generators are affordable but have the least efficiency and are commonly found for residential applications. 3-phase generators are more efficient than single-phase and 2-phase generators but are not 100% efficient and are commonly used for industrial applications.

Therefore, there exists a long-felt need in the art of an electric generator designed to produce environmentally friendly electric power. There is also a long-felt need in the art for an electric generator that is more efficient than existing single, 2-phase, and 3-phase generators. Additionally, there is a long-felt need in the art for a novel electric generator that can be used for both residential and industrial applications. Further, there is a long-felt need in the art of an electric generator that consumes less power to generate electricity. Finally, there is a long-felt need in the art for a 4-phase electric generator that is configured to reduce harmful effects on the environment, such as greenhouse gas emissions.

The subject matter disclosed and claimed herein, in one embodiment thereof, comprises a 4-phase motor and generator device. The device is configured to be more efficient than single-phase, 2-phase, and 3-phase generators and is environmentally friendly.

### SUMMARY OF THE INVENTION

The following presents a simplified summary to provide a basic understanding of some aspects of the disclosed innovation. This summary is not an extensive overview and is not intended to identify key or critical elements or to delineate the scope. Its purpose is to present certain concepts in a simplified form as a prelude to the more detailed description that follows.

In one embodiment, the subject matter disclosed herein comprises a four-phase AC generator and eccentric mass load subsystems. The generator is configured to operate more efficiently than single-phase, two-phase, and three-phase generators while providing improved control over eccentric mass loads. A generally circular or cylindrical stator wall carries eight stator slots arranged as four opposing pairs (A-A, B-B, C-C, D-D). Each opposing pair is bridged by a coil that is terminated at a neutral star node, and each coil provides two neutral-referenced slot terminals. The resulting topology yields eight electrical outputs that can be processed as four-phase AC waveforms and/or rectified to slot-level direct current (DC) as required by a control panel.

A permanent-magnet armature having four north and four south poles rotates relative to the stator wall. The magnetic geometry is selected so that the eight stator poles are actively magnetically coupled to the armature throughout the electrical cycle, with different ones of the four phases successively experiencing peak and zero-crossing conditions. This arrangement shapes the four-phase AC waveforms and reduces ripple when the slot-level outputs are rectified, improving efficiency relative to conventional three-phase and single-phase machines. The generator outputs can be routed through a control panel to supply power to eccentric mass load subsystems, auxiliary motors, and a lithium battery bank. A solar panel distribution arrangement may provide additional regulated inputs to the lithium battery bank and control panel.

In some embodiments, dual eccentric mass load subsystems are mechanically coupled to the generator output shafts. Each subsystem may include an auxiliary frame, an orbital frame, orbital members, and eccentric masses arranged about a central axis. The four-phase AC generator supplies electrical power for driving the orbital members such that eccentric masses follow prescribed trajectories about the center axis. By coordinating rotations of the eccentric mass subsystems, the system can generate a mostly straight-line resultant translational force or provide vibration management in terrestrial applications.

In other embodiments, the four-phase AC generator and eccentric mass load subsystems may be configured for use on spacecraft, satellites, or other platforms operating in a low-gravity or microgravity environment. The generator may supply four-phase AC and rectified DC power to drive orbital frames and eccentric masses that function, for example, as reaction-wheel or momentum-exchange devices to assist with payload repositioning, attitude control, vibration management, debris handling, or resource transport operations. References to gravitational and outer-space environments are provided to illustrate potential system-level integrations and application contexts for the four-phase AC generator and eccentric mass load subsystems; the disclosed embodiments rely on conventional electromechanical principles without requiring non-Newtonian physics

In yet another embodiment, the subject matter disclosed herein comprises a method of operating a four-phase AC generator and eccentric mass load subsystems. The method includes rotating a permanent-magnet armature relative to a stator wall having eight stator slots arranged as four opposing pairs; inducing four-phase AC voltages in coils that bridge each opposing pair and connect to a neutral node; delivering eight neutral-referenced outputs that are selectively processed as four-phase AC waveforms and/or slot-level DC; and supplying electrical power to eccentric mass load subsystems that rotate eccentric weights about a center axis of rotation. The coordinated rotation of the eccentric masses generates translational forces and/or vibration compensation while the four-phase AC generator provides improved electrical efficiency compared to single-phase, two-phase, or three-phase generators.

The four-phase AC generator and eccentric mass load subsystems may be manufactured using stacked magnetic-iron laminations for the stator wall and copper windings for the coils, enabling cost-effective construction and integration into terrestrial or space-based platforms. Numerous benefits and advantages will become apparent to those skilled in the art upon reading the detailed description and reviewing the accompanying drawings.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

In one embodiment, the generator is configured to be more efficient than three-phase generators. The device may comprise a stator wall having a circular or cylindrical shape, four stator slots disposed in the stator wall, the four stator slots are divided into four groups of two opposing stator slots

In another aspect of the present disclosure, the stator slots may be arranged in a symmetrical pattern around the stator wall.

In yet another embodiment, the stator wall may be made of a magnetic iron lamination material.

In yet another embodiment, the four-phase motor and generator device of the present disclosure is easily and efficiently manufactured, marketed, and available to consumers in a cost-effective manner and is easily used by users for generating power in numerous ways, like powering electric power plants, homes, vehicles, and more.

The permanent magnet in the main armature may be rotated by a separate mechanical system, to induce a current to the stator wall as the main armature revolves around the center axis of rotation as displayed in FIGS. 10-15 and 17-19.

Numerous benefits and advantages of this disclosure will become apparent to those skilled in the art to which it pertains upon reading and understanding the following detailed specifications.

To the accomplishment of the foregoing and related ends, certain illustrative aspects of the disclosed innovation are described herein in connection with the following description and the annexed drawings.

### BRIEF DESCRIPTION OF THE DRAWINGS

The description refers to provided drawings in which similar reference characters refer to similar parts throughout the different views, and in which:

FIG. 1 illustrates an internal view of an embodiment of a four-phase motor and generator with eight electrical load outputs of one potential embodiment of the present disclosure;

FIG. 1K illustrates the alternating current stator wall with four North and four South poles opposite each other, labeled as four phase A, B, C, D opposite each other on the stator wall, and the armature with a North and South pole;

FIG. 2 illustrates an embodiment of the present disclosure comprising four armatures configured to rotate inside a stator wall;

FIG. 2K displays four phase alternating current Phase A, Phase B, Phase C, and Phase D with Peak Voltage 1 Vac;

FIG. 3 illustrates an embodiment of the present disclosure comprising four armatures configured to rotate inside a stator wall;

FIG. 3K displays alternating current Peak Voltage in this Model is 1 Volt, The RMS Voltage in this Model is 0.768 Volts, A Phase, B Phase, C Phase and D Phase;

FIG. 4 illustrates an embodiment of a four-phase generator and eccentric mass load subsystems of the present disclosure;

FIG. 5 illustrates an embodiment of the present disclosure wherein armatures have a phase relationship with one or more stator walls;

FIG. 6 illustrates an embodiment of the present disclosure wherein eccentric mass loads share the same center axis of rotation and distances from the center axis of rotation of eccentric mass loads;

FIG. 7 illustrates an embodiment of the present disclosure wherein eccentric mass loads share the same center axis of rotation and distances from the center axis of rotation of eccentric mass loads;

FIG. 8 illustrates a timing gear arrangement according to embodiments of the present disclosure;

FIG. 9 illustrates a four-phase stator/armature polarity snapshot at a representative instant in the electrical cycle;

FIG. 10 illustrates an embodiment of the present disclosure at Time Interval 0, Positive Peak Voltage 1 Volt D phase, Negative Peal Voltage B phase, A phase Zero Volts, C phase 0 Volts.

FIG. 11 illustrates an embodiment of the present disclosure at Time Interval 1.75, RMS Voltage Positive +0.7068 Volts D phase, RMS Voltage Negative −0.7068 Volts, A phase RMS Voltage Negative −0.0768 Volts, C phase RMS Voltage Positive +0.7068 volts.

FIG. 12 illustrates an embodiment of the present disclosure at Time Interval 1.50, Zero Volts Null Voltage D phase, B phase Zero Volts Null Voltage, A Phase Peak Voltage Negative 1 Volt, C Phase Peak Voltage Positive +1 Volt.

FIG. 13 illustrates an embodiment of the present disclosure at Time Interval 1.25, RMS Voltage Negative −0.0768 Volts D phase, RMS Voltage Positive +0.7068 Volts, A phase RMS Voltage Negative −0.0768 Volts, C phase RMS Voltage Positive +0.0768 Volts.

FIG. 14 illustrates an embodiment of the present disclosure at Time Interval 1.00, Peak Voltage Negative− Volt D phase, B phase Peak Voltage Positive +1 Volt, A phase Zero Volts Null Voltage, C phase Zero Volts Null Voltage.

FIG. 15 illustrates an embodiment of the present disclosure at Time Interval 0.75, RMS Volts Negative −0.7068 Volts D phase, B phase RMS Voltage +0.7068 Volts, A phase RMS Voltage Positive +0.7068 Volts, C phase RMS Voltage Negative−0.7068Volts.

FIG. 16 illustrates an embodiment of the present disclosure at Time Interval 0.50, Zero Volts D phase, B phase Zero Volts, A phase Peak Voltage 1 Volt Positive +, C phase Peak Voltage 1 Volt Negative −.

FIG. 17 illustrates an embodiment of the present disclosure at Time Interval 0.25, RMS Voltage Positive +0.7068 Volts D phase, B phase RMS Voltage Negative −0.0768 Volts, A phase RMS Voltage Positive +0.7068 Volts, C phase RMS Voltage Negative −0.0768 Volts.

FIG. 18 illustrates an embodiment of the present disclosure at Time Interval 2.00, (Back to start), Peak Voltage Positive +1 Volt D phase, B phase Peak Voltage Negative-Volt, A phase Zero Volts Null Voltage, C phase Zero Voltage.

### DETAILED DESCRIPTION OF THE PRESENT INVENTION

The disclosure is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

There is an ongoing demand for an electric generator that produces environmentally friendly sustainable power. Additionally, there remains a need for an electric generator which is more efficient than existing single, two-phase, and three-phase generators. Further, there is a need for a generator adaptable for both residential and industrial applications. Moreover, a generator with improved rotor balance that minimizes excessive vibrations is desirable. There is also a demand for generators that require less input power for generating electricity. Finally, a four-phase electric generator capable of reducing harmful environmental effects, such as greenhouse gas emissions, is needed.

The subject matter disclosed and claimed herein, in one embodiment, comprises a four-phase generator and eccentric mass load subsystems. The device is designed to operate more efficiently than single-phase, two-phase, and three-phase generators and to be more environmentally friendly. The device further comprises a stator wall having a circular or cylindrical shape and eight stator slots disposed in the stator wall. The eight stator slots are arranged into four pole groups of two opposing stator slots. Each pair of opposing slots is connected via a common coil; the common coil also connects to an electrical output and to a neutral point. One slot of each opposing pair has North polarity (an N stator slot) and the other slot has South polarity (an S stator slot). Four of the stator slots on one side of the stator wall correspond to the other four stator slots on an opposing side of the stator wall. An armature is positioned concentrically with the stator wall, and the device is configured to alternate activation between N stator slots and S stator slots of the four pole groups in response to rotation of the armature, such that the eight stator poles are actively coupled in a four-phase pattern that produces phase-shifted peak and zero-crossing conditions over the electrical cycle.

In this manner, the four-phase motor and generator addresses the forgoing needs by providing efficient and environmentally friendly power generation. The generator may be applied in a wide range of contexts, including residential power, vehicles, and other applications. Further, the generator reduces environmental impact, including greenhouse gas emissions.

Still further, there remains a need for an electric generator that can reliably drive eccentric mass loads or eccentric rotor masses rotating about a central axis for use in vibration isolation, force generation, and motion control systems. In terrestrial applications, such eccentric mass systems may be used in shaker tables, vibratory conveyors, vehicle suspension test stands, or seismic simulators. In space-based platforms, controlled eccentric mass motion can be employed in devices such as reaction wheels, momentum-exchange assemblies, or tunable dynamic absorbers to manage attitude, vibration, and structural loads.

In systems with eccentric mass configurations, the distribution of mass around the axis of rotation is non-uniform, and the instantaneous angular momentum of each rotating assembly depends on the mass, its radial distance from the axis, and its angular velocity. Coordinated operation of multiple eccentric masses can be used to shape the net forces and moments transmitted to a supporting frame. For example, synchronized counter-rotating eccentric masses may be arranged to cancel net torque while generating a predominantly translational force vector along a selected direction, which can be exploited for controlled vibration, positioning, or load management.

Accordingly, there is a need for a compact, efficient electrical generator and control architecture capable of supplying multi-phase power to coordinated eccentric mass subsystems in both terrestrial and space-based environments. Such a system should support precise control of rotational speed, phase, and direction of the eccentric masses, enabling applications including vibration management, payload repositioning, satellite maintenance, space debris handling, and resource extraction operations. The present disclosure addresses these needs by integrating a four-phase generator topology with controllable eccentric mass load subsystems and associated control electronics.

The present disclosure, in one exemplary embodiment, provides a method of operating a four-phase generator and eccentric mass load subsystems. The method comprises rotating an armature relative to a stator wall, the stator wall having a circular or cylindrical shape and eight salient poles (“stator slots”) divided into four pole groups, each pole group including an N (North) stator slot and an S (South) stator slot, wherein four of the stator slots on one side of the stator wall correspond to the other four stator slots on an opposing side of the stator wall. The method further comprises alternating activation between N stator slots and S stator slots of the four pole groups in response to rotation of the armature, such that the eight stator poles are actively coupled in a four-phase pattern that produces phase-shifted peak and zero-crossing conditions over the electrical cycle, and generating electrical energy with increased efficiency compared to single-phase, two-phase, or three-phase motors.

For the present disclosure, an eccentric load or rotor mass diagram is considered as a rotor unbalance diagram and is a graphical representation of the eccentricity of the rotor mass in a generator. The diagram is used to determine the amount and location of unbalance in the rotor and to ensure that the generator runs smoothly without causing excessive vibrations. The eccentric load or rotor mass diagram shows the location and magnitude of the unbalance forces acting on the rotor due to the eccentricity of the rotor mass.

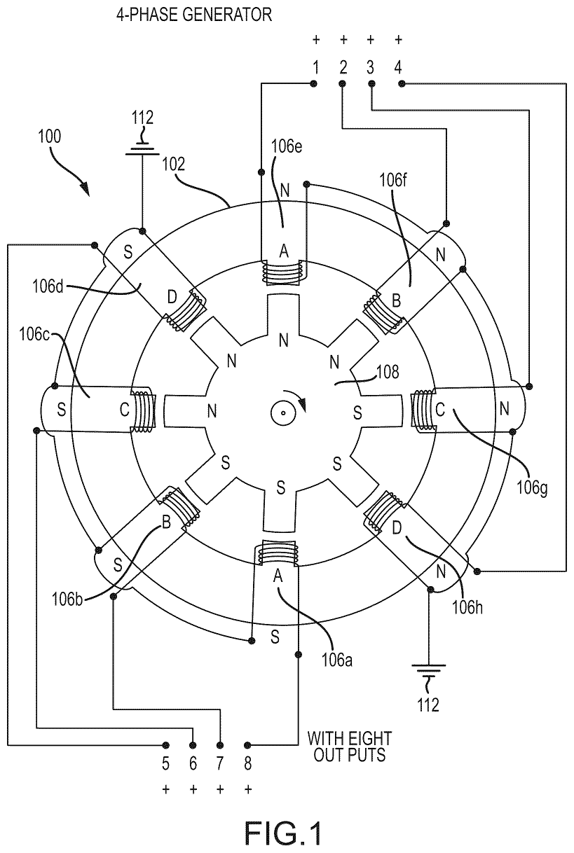

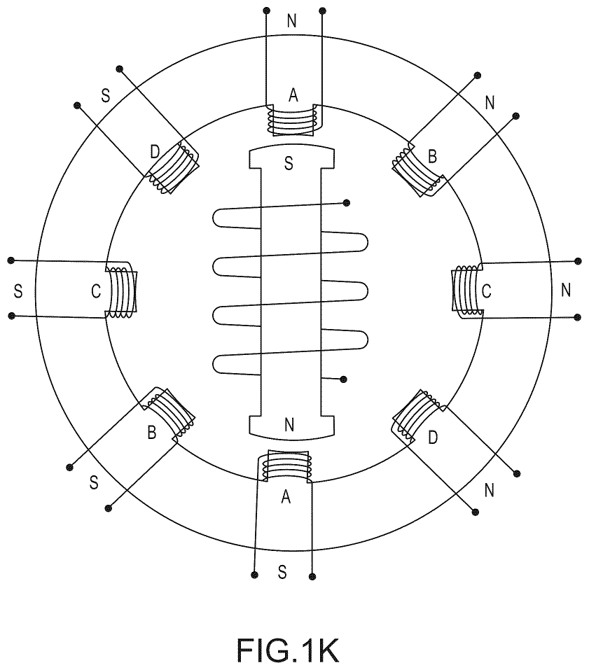

FIG. 1 illustrates an internal view of an embodiment of a four-phase motor and generator with eight electrical load outputs in accordance with the disclosed architecture. The four-phase motor and generator 100 of the present disclosure is configured as an electrical machine. The four-phase motor and generator 100 is more efficient than conventional generators and consumes less energy. More specifically, the machine 100 includes a stator wall 102 and an armature 108. The stator wall 102 features four phases of functional operation, which is an advantage over existing single-phase, two-phase, and three-phase motors. As illustrated, the stator wall 102 has eight stator slots 106a, 106b, 106c, 106d, 106e, 106f, 106g, 106h denoted as “A-A” 106a, 106e; “B-B” 106b, 106f; “C-C” 106c, 106g; and “D-D” 106d, 106h. Four stator slots, 106a, 106b, 106c, and 106d, on one side of the stator wall 102, correspond to the other four stator slots, 106e, 106f, 106g, and 106h, for a symmetrical polarity on the stator wall 102. Preferably, the North polarity stator slots (106d, 106e, 106f, 106g) are positioned on one side of the stator wall 102, and the South polarity stator slots (106a, 106b, 106c, 106h) are positioned on the other side of the stator wall 102. The stator slots are arranged in a symmetrical pattern around stator wall 102, and stator wall 102 has a circular or cylindrical shape.

Some embodiments further illustrate the four pole groups configured on stator walls 102, and each pole group includes a pair of corresponding stator slots on opposing sides of the stator walls 102. As a result, the one pole group is defined by two “A-A” stator slots, and similarly, other pole groups are defined by corresponding “B-B” stator slots together, “C-C” stator slots together, and “D-D” stator slots together. During use, the rotation of the armature 108 causes the four pole groups to alternate in activation between N (North) stator slots and S (South) stator slots. The armatures'108 rotating magnetic fields within the stator wall 102 generates an electrical current in the stator wall 102. This configuration is beneficial because the eight poles are actively coupled in any given configuration, which results in electrical energy being generated with eight outputs.

Some embodiments further illustrate the four pole groups configured on stator wall 102, each pole group including a pair of corresponding stator slots on opposing sides of the stator wall 102. As a result, one pole group is defined by the two “A-A” stator slots, and similarly, other pole groups are defined by the corresponding “B-B,” “C-C,” and “D-D” stator slots. During use, rotation of the armature 108 causes the four pole groups to alternate in activation between N stator slots and S stator slots. The rotating magnetic field of the armature 108 within the stator wall 102 induces electrical current in the stator slots 106a-106h. The magnetic geometry is selected so that the eight stator poles cooperate with the rotating armature field to produce four phase-shifted waveforms with well-defined peak and zero-crossing conditions, thereby providing eight neutral-referenced slot-level outputs and improved waveform quality.

Some embodiments further illustrate an embodiment of the present disclosure in which the four-phase generator 100 forms four pole groups that alternate between N stator slots and S stator slots, thereby generating more electrical energy than existing single-phase, two-phase, and three-phase machines for a given input and thus increasing energy efficiency. Further, the four-phase generator 100 can reduce harmful environmental effects, such as greenhouse gas emissions, by enabling more efficient electric power generation. In a preferred embodiment, the stator slots 106a-106h provide eight neutral-referenced electrical outputs (designated 1-8) rather than eight distinct phases. As illustrated, the slot terminals associated with slots 106e, 106f, 106g, and 106h are referenced to neutral node 112, and the slot terminals associated with slots 106a, 106b, 106c, and 106d are likewise referenced to neutral node 112 via their respective coils.

In another embodiment, a respective phase coil is connected between each pair of opposing stator slots. The slot terminals of these coils define eight neutral-referenced electrical outputs 1-8, and the opposite ends of the coils are commonly connected to the neutral point 112.

FIG. 1K illustrates, in simplified schematic form, an Alternating Current (AC) stator wall and armature arrangement for a four-phase machine. The stator wall 102 is represented with four North (“N”) and four South (“S”) stator poles, arranged in alternating fashion around the circumference. The stator poles are grouped into four opposing pole pairs that define the four electrical phases A, B, C, and D. In the illustrated embodiment, each phase is realized by a diametrically opposed N/S pair, and the four phase groups A-D are disposed at approximately 90 electrical degrees from one another. The armature 108 is shown concentrically within the stator wall 102 and carries a representative permanent-magnet pattern with North and South poles oriented so as to couple magnetically to the stator poles as the armature rotates. FIG. 1K thus depicts the underlying four-phase topology in which eight stator poles (four N and four S) cooperate with the permanent-magnet armature 108 to induce phase voltages in the coils that span the corresponding opposing stator slots.

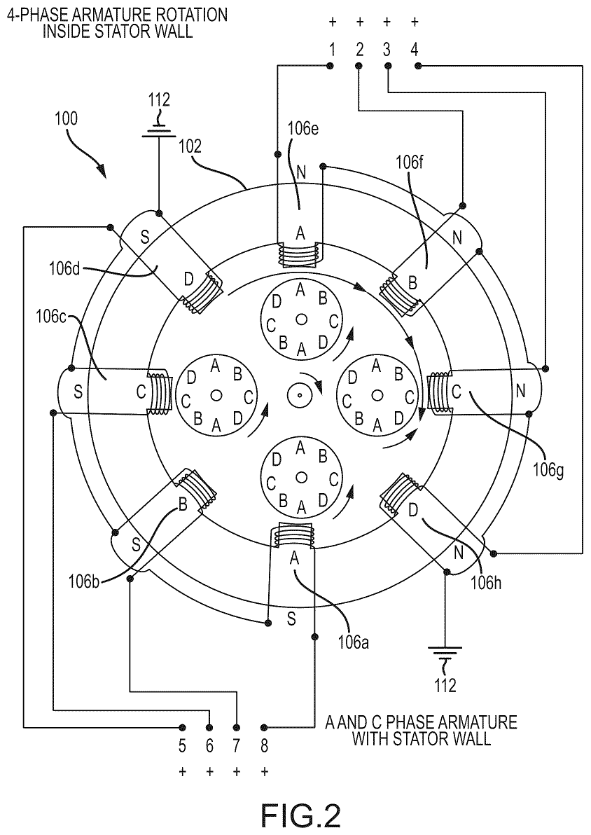

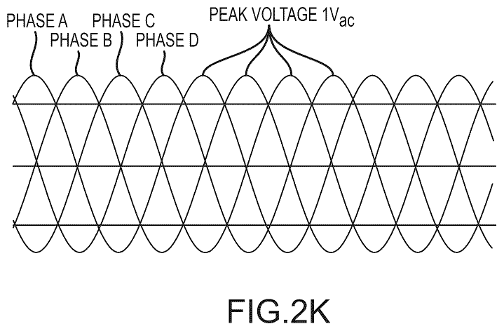

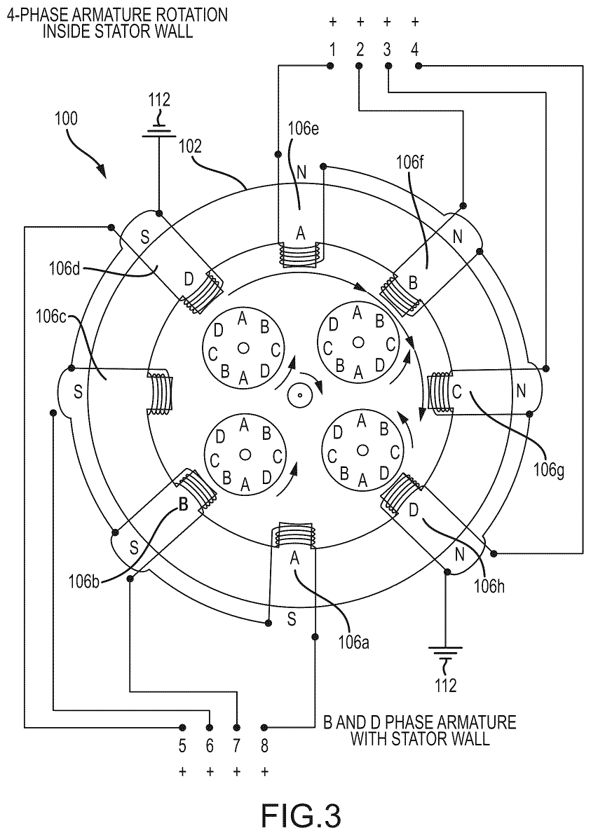

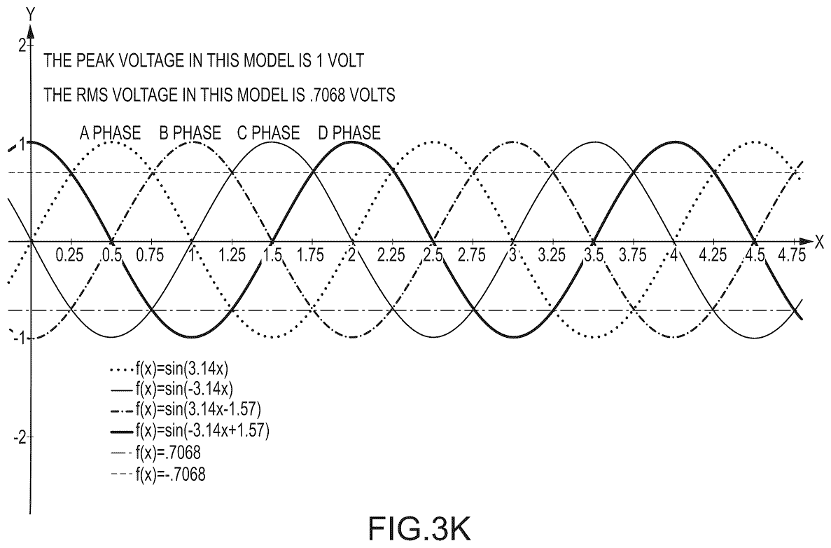

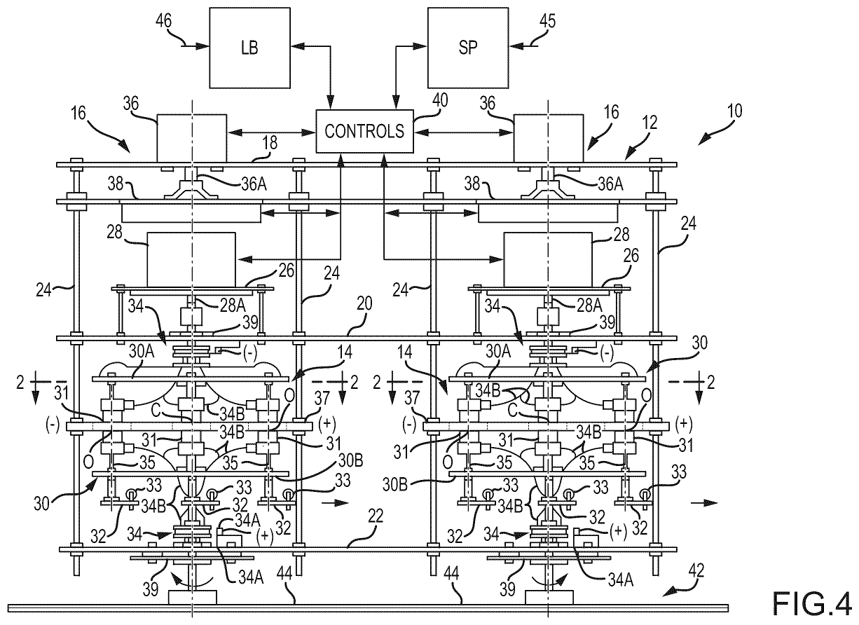

FIG. 2 and FIG. 3 illustrate four armature rotations inside the stator wall, which receives its power from the eight electrical load outputs as illustrated in FIG. 1. FIG. 4 illustrates eight armatures 30, four on the left and four on the right sides of the drawing, wherein four of the armatures rotate clockwise and the other four armatures rotate counterclockwise.

As illustrated in FIG. 2, phase A may be formed by opposing stator slots 106a and 106e, phase B may be formed by opposing stator slots 106b and 106f, phase C may be formed by opposing stator slots 106c and 106g, and phase D may be formed by opposing stator slots 106d and 106h. The voltage of each phase is formed when the permanent magnet 108 aligns with the opposing stator slots.

In some embodiments the South pole and North pole of the permanent magnet 108 align with the opposing stator slots 106e, 106a, respectively, and as a result, the peak voltage of phase A may be achieved. As the armature permanent magnet 108 rotates and aligns with other sets of opposing stator slots, the voltage and current are generated. The permanent magnet 108 may be, but is not limited to, a permanent or rare earth magnet inside of the lamination of the armature 108.

FIG. 2K schematically displays an idealized four-phase alternating-current waveform set corresponding to phases A, B, C, and D. In the illustrated example, each phase has a peak magnitude of approximately 1 Vac (normalized units), and the phases are uniformly separated by 90 electrical degrees. The figure is intended to illustrate a balanced four-phase system in which the instantaneous sum of the four phase voltages may be controlled and various combinations of phase-to-phase and phase-to-neutral voltages can be derived for driving eccentric mass motors, auxiliary loads, or power-electronic converters. While FIG. 2K depicts sinusoidal waveforms with equal amplitude and a particular peak value, other voltage magnitudes, frequencies, and waveform shapes (for example, trapezoidal or pulse-width-modulated waveforms) may be used in alternative embodiments while still preserving the four-phase relationship among phases A-D.

FIG. 3K graphically illustrates exemplary mathematical models for the four-phase AC waveforms. In the depicted normalized model, the peak voltage of each phase is 1 volt and the corresponding RMS voltage is approximately 0.7068 volts. By way of example, the four phase voltages may be represented as sinusoidal functions of a normalized time variable x, such as f_A(x) =sin(3.14x), f_B(x)=sin(3.14x−1.57), f_C(x)=sin(−3.14x), and f_D(x)=sin(−3.14x+1.57), where successive phase angles differ by approximately 90 electrical degrees. Constant reference lines at +0.7068 and −0.7068 volts illustrate the RMS magnitude envelopes. These functions are illustrative only; in practice, the electrical frequency, voltage magnitude, and phase displacement can be selected to suit a particular application, and non-sinusoidal waveforms may be employed, provided that the generator and associated control electronics establish a coordinated multi-phase set suitable for driving the eccentric mass load subsystems and other loads.

FIG. 4 illustrates an embodiment of the present disclosure comprising a controlled translational force generating system 10. The system 10 may comprise a control panel 40, a plurality of direct current motors 36, and generators 38. Embodiments may further comprise a lithium battery bank 42 and a solar panel distribution arrangement 41. A plurality of conduits may be configured to extend from the control panel 40 to motors 28 and 36 and to generators 38, and may also be configured to join communication rings 34 and 34A (not illustrated).

In certain embodiments, as illustrated in FIG. 4, the system 10 may operate in either the Earth's gravitational field or on a space-based platform. A set of initial translational forces may be generated by subsystems 14 through interaction between the eccentric mass loads 33, 32 and the main frame 12 or a supporting structure. By appropriately phasing and synchronizing the eccentric mass subsystems 14, the system 10 can produce a resultant translational force vector along a selected direction, which may be used for controlled vibration, positioning, or load management in terrestrial or space-based application.

As further shown in FIG. 4, direct current motors 36 may comprise shafts 36A that are mechanically coupled to the permanent magnetic armature 108 of the four-phase generator 100, as illustrated in FIG. 1. The permanent magnetic armature 108 may be configured to rotate within the stator wall 102, inducing current when the direct current motors 36 operate. As shown in FIG. 1, stator wall 102 may be configured to produce output currents 1, 2, 3, 4, 5, 6, 7, and 8 for output electric loads. This occurs as a result of the axial air gap of the permanent magnetic armature 108, which induces current flow into the windings of stator wall slots 106a, 106b, 106c, 106d, 106e, 106f, 106g, and 106h.

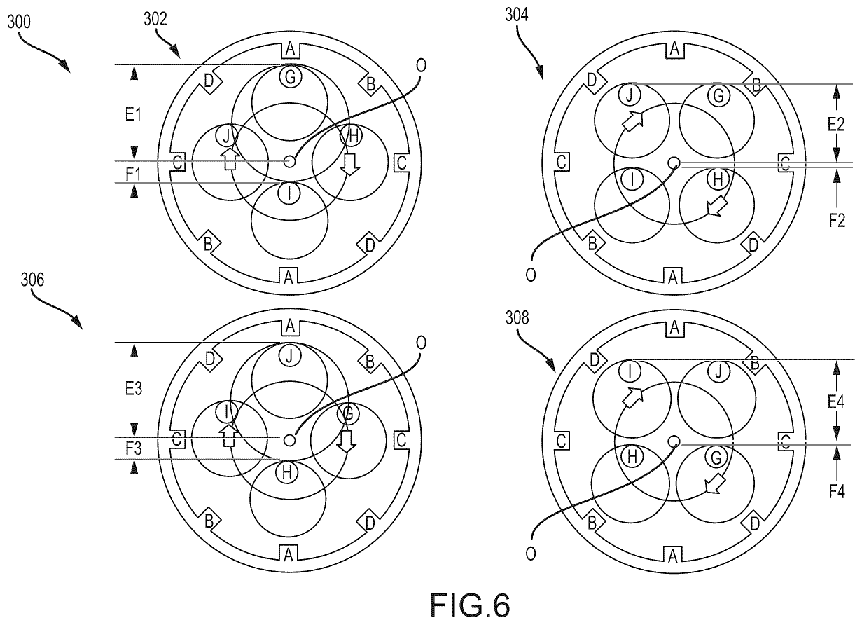

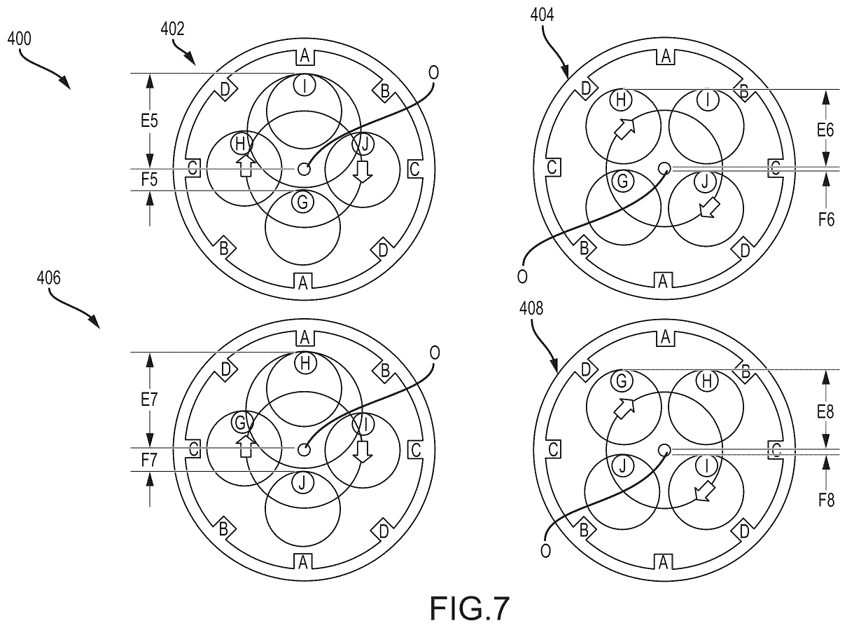

In some embodiments, by variably adjusting the rotations per minute of the parallel eccentric mass loads 33, the magnitude and direction of the resultant translational force applied to the system 10 can be controlled, with the eccentric mass loads 33 effectively defining an arrow indicating the predominant force vector. Details of exemplary eccentric mass load arrangements are provided in FIG. 6 and in the operational sequence of FIG. 7.

In some embodiments, the main frame 12 may comprise upper horizontal platforms 18, middle horizontal platforms 20, and lower horizontal platforms 22, supported in vertically spaced relation by vertical legs 24. By way of illustration only, rather than a limitation, horizontal platforms 18, 20, and 22 are depicted as rectangular in shape. Vertical legs 24, eight in number (with only four shown along one of the opposite sides of frame 12), may be attached to and support the horizontal platforms 18, 20, and 22 at spaced locations along their perimeters.

In yet other embodiments, the controlled translational force generating system 10 may comprise a first and second set of subsystems 14 mounted on a main frame 12 and may be configured to generate translational forces through the second set 33 and 32.

As illustrated in FIG. 4, each direct current motor 36 may comprise a center shaft 36A, as also shown in FIG. 1. The center axis shaft of the permanent magnetic armature 108 may be mechanically coupled to shaft 36A. Each generator 38 may represent the four-phase motor and generator 100 with eight outputs as illustrated in FIG. 1.

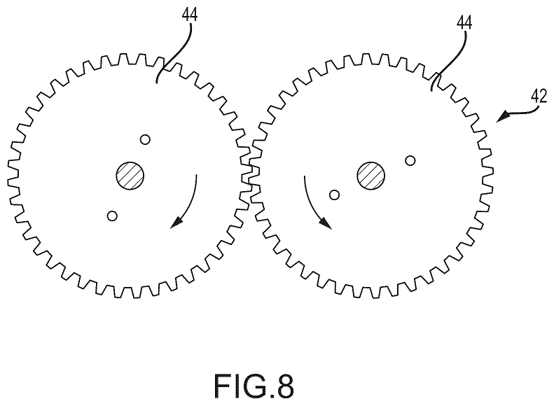

As further illustrated in FIG. 4, system 10 includes synchronizing assembly 42 in the form of a pair of large timing gears 44 (as further illustrated in FIG. 8). These gears are mounted in the same horizontal plane, have equal diameters, and are in peripheral engagement with one another. They are connected to the lower ends of orbital frame center axis shafts 30.

In some embodiments, the control panel 40 may be electrically joined to the direct current motors 28 and 36, the generators 38, and the communication rings 34, 34B, and 34A.

Some embodiments further illustrate armature coils soldered to the top and bottom of a copper communications ring. The brushes may be mechanically attached to a shaft with dielectric hardware. From the brushes, a conductor segment may be connected to a control panel configure to regulate current. The control panel may selectively load or unload current to or from the coils of each of the four armatures, in communication with the lithium batteries, via automated or manual controls or voltage and current for each armature.

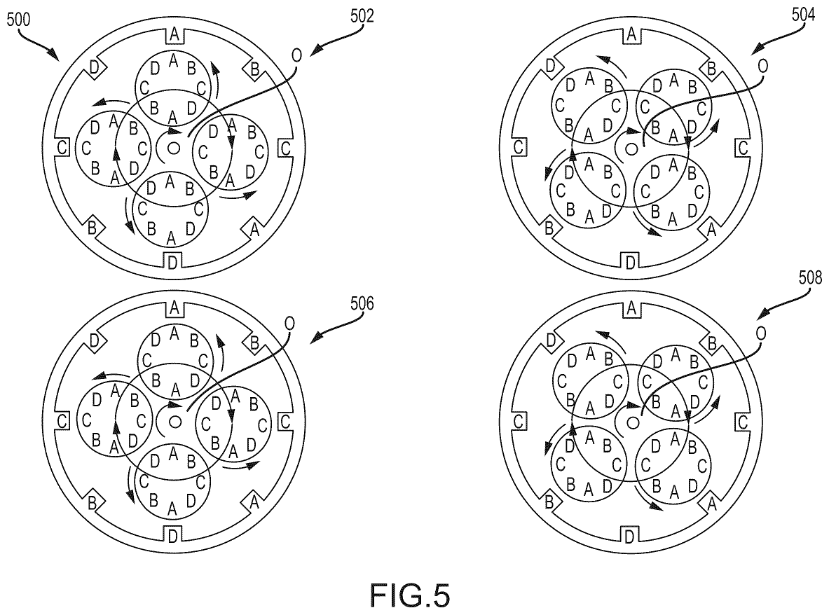

FIG. 5 illustrates the armatures'“A” and “C” phase relationship with the stator walls “A” and “C” phases as the armatures in FIG. 2 and FIG. 3 revolve clockwise or counterclockwise about the center axis of rotation of the present disclosure. Some embodiments further illustrate electromagnetic functions of four armatures within the stator wall, configured to provide the means for generating an eccentric load mass to rotate inside the stator wall. The diagrams 502, 504, 506, and 508 depicted in FIG. 5 illustrate embodiments of the four-phase generator and eccentric mass load subsystems 100 of FIG. 1. Some embodiments illustrate four armatures'electrical/magnetic relationships with, for example, the stator wall. As shown, the rotation of the center axis “O” is clockwise. However, the rotation can be arranged in a counterclockwise orientation as well. Diagram 502 illustrates a power source providing power to the armatures and stator wall, resulting in the armatures revolving about the center axis of rotation “O” and facing a first direction. The stator and armature of diagram 502 displays the four-phase stator wall magnetic relationship with the four-phase armatures, with “A” and “C” phase power first. Diagram 502 represents a display of the “A” and “C” phase power stator wall and energized armatures. Diagram 504 illustrates a power source providing power to the armatures and stator wall, resulting in the armatures revolving about the center axis of rotation “O” and facing a second direction. The stator and armature of diagram 504 display the four-phase stator wall magnetic relationship with the four-phase armatures with “B” and “D” phase power second. Thus, Diagram 504 represents a display of the “B” and “D” phase power stator wall and energized armatures. Diagram 506 illustrates a power source providing power to the armatures and stator wall, resulting in the armatures revolving about the center axis of rotation “O” and facing the first direction. The stator and armature of Diagram 506 displays the four-phase stator wall magnetic relationship with the four-phase armatures with “C” and “A” phase power third. Thus, Diagram 506 represents a display of “C” and “A” phase power stator walls and energized armatures. Diagram 508 illustrates a power source providing power to the armatures and stator wall, resulting in the armatures revolving about the center axis of rotation “O” and facing the second direction. The stator and armature of diagram 508 displays the four-phase stator wall magnetic relationship with the four-phase armatures with “D” and “B” phase power fourth. Thus, Diagram 508 represents a display of the “D” and “B” phase power stator wall and energized armatures. The full revolution cycle repeats from 508 to 502, next to 504, and then to 506, resulting in armatures revolving about the center axis of rotation and facing the same direction while revolving about the center axis of rotation. The revolutions per minute of the center axis of rotation shall be increased or decreased to maximize or minimize the effects of the eccentric mass load upon the center axis of rotation for translational force generation to move the system in a direction that is constant.

Some embodiments further illustrate a first system rotating in a counterclockwise motion about its center axis and a second system rotating in a clockwise motion about its center axis of rotation. These systems, 502, 504, 506, and 508, are optionally arranged in succession so that the eccentric load mass may be configure to peak at the “A” phase to control the effects of the eccentric mass loads upon the center axis of rotation O, resulting in the systems as illustrated in FIG. 6 moving in the direction of greatest distance of eccentric mass loads “J,” “G,” “H,” and “I,” defined as “E1,” “E2,” “E3,” “E4,” “E5,” “E6,” “E7,” and “E8,” distances from the center axis of rotation “O”.

Some embodiments disclose the eccentric mass on each of the four-phase armatures, moving the systems in the direction of the eccentric mass loads “G,” “H,” “I,” and “J” out furthest from the center axis of rotation. The top and bottom of each of the four armatures will have a single brush top and a single brush bottom, and conductor segments that go to a control panel where amps are regulated to the armature's windings.

FIG. 6 illustrates the eccentric load mass diagram for the functioning of the four-phase generator and eccentric mass load subsystems of the present disclosure by the disclosed architecture. The eccentric load mass diagram 300 illustrates a graphical representation of the eccentric mass in the four-phase armatures rotation inside the stator wall 102. In FIG. 6 and FIG. 7, the diagram illustrates the relationship between the stator wall 102 and the eccentric load masses.

FIG. 6, further illustrates an embodiment of the present disclosure wherein four circles each correspond with one phase of the four-phase motor and generator. The first circle 302 indicates the starting point of the rotation of the center axis of the rotor, which is clockwise in this case. However, the four-phase motor and generator 100 can also be wired for counterclockwise rotation per the application if required. In the first circle 302, the “A” phase Axial air gap from the stator wall “G” is minimal, and distance “E1” extends from the center axis of rotation.

In other embodiments, the eccentric load mass is indicated by the letter “G,” which is located at a distance “E1” from the center axis of rotation “O”. The eccentric load mass is indicated by the letter I and is located at a distance “F1” from the center axis of rotation “O”. Additionally, the first circle 302 shows the location of the eccentric load mass, indicated by the letter J,” and the location of the eccentric load mass, indicated by the letter “H”.

In yet another embodiment, a second circle 304 illustrates the eccentric load mass G and J, wherein both are located at a distance “E2” from the center axis of rotation “O”, while the eccentric load mass “I” and “H” are located at a distance “F2” from the center axis of rotation “O”.

In another embodiment, a third circle 306 illustrates the eccentric load mass J which is positioned at a predefined distance “E3” from the center axis of rotation “O”, while the eccentric load mass H is positioned at a distance F3 from the center axis of rotation “O”.

In another embodiment, a fourth circle 308 illustrates the eccentric load mass I and J, wherein both are positioned at a distance E4 from the center axis of rotation “O”, while the eccentric load mass H and G are positioned at a distance F4 from the center axis of rotation “O”.

FIG. 6 and FIG. 7 further illustrate embodiments wherein the eccentric mass loads “G,” “H,” “I” and “J” share the center axis of rotation “O” as illustrated in FIG. 5, thereby allowing the stator wall and armatures to maintain the eccentric mass loads at a distance “E” and “F” from the center axis of rotation “O” of the present disclosure.

FIG. 6 and FIG. 7 further detail operations of the eccentric mass loads of subsystems mounted inside the main frame 12 located within box 38 as illustrated in FIG. 4. The eccentric mass loads may be configured to have the same mass weight.

FIGS. 4, 6, and 7, further illustrate an embodiment of the present disclosure wherein each of the parallel eccentric mass load subsystems 14 of the controlled translational force-generating systems 10 which generate the respective initial translational forces may be configured to include an auxiliary frame 26, a rotary drive motor 28, an orbital frame 30, a plurality of first orbital members 32, and a communications ring dielectric to shaft 34, 34A, wherein the carbon electric brush may be insulated from electrical contact and mounted on a deck 22. The rotary drive motor 28 may be mounted to the auxiliary frame 26 and may have a rotary output shaft 28A extending downwardly through the auxiliary frame 26. The orbital frame 30 may be mounted to the legs 24 of the main frame 12 and joined to the rotary output drive shaft 28A of the rotary drive motor 28 for, but not limited to, undergoing revolutions about a central axis “C” upon operation of the rotary drive motor 28. The orbital frame 30 may be composed of an upper deck 30A and horizontal deck 30B, and a plurality of support shafts 35 configured to extend between and journaled at opposite ends by bearings 39 to the upper and lower decks 30A, 30B. The first orbital members'32 eccentric mass load devices may be mounted on the orbital frame 30 and configured to undergo revolutions with the orbital frame 30 about the central axis “C”.

In some embodiments, the eccentric mass loads first orbital members 32 may also be mounted to the orbital frame 30 and configured to undergo rotation about an orbital axis “0” relative to the orbital frame 30. Each of the first orbital members 32 may be further configured to support eccentric mass load weights 33, which may be used to define an offset center of mass of the respective first orbital members 32. Thus, the first orbital members 32 may have their centers of mass predisposed eccentric mass load in relation to a preset angular position relative to the respective orbital axes “0”.

In some embodiments, electrical coupling mechanisms 34, which may include electrical brushes 34A and electrical conductors 34B, may be electrically coupled to a plurality of second orbital members 31 for providing predetermined levels of electrical power, producing rotation of the second orbital members 31 in a first direction about their orbital axes “0” at the same frequency as the first orbital members 32, undergoing revolutions with the orbital frame 30 in a second opposite direction about the central axis “C”. In such a manner, the center of eccentric mass loads of orbital members 32 may be maintained at the respective preset angular position relative to orbital axis “0” and thereby the first orbital members 32 may be asymmetrically accelerated relative to the central axis “C” to impart a respective one of an initial translational force to the main frame 12 of the system 10.

In yet other embodiments, the electromagnetic implementation of the eccentric load mass subsystems 14 and the first orbital members 32 may share the same shaft as the orbital armatures mounted to support the shafts 35, and the rotation-producing coupling may stand for an annular stator 37 stationarily mounted to legs 24 of the main frame 12 and configured to surround the orbital armatures. The orbital armatures may preferably be four in number as illustrated in FIG. 2 and FIG. 3, and in an electromagnetic relationship with the stator wall 37. Direct Current (DC) variable voltage power may be supplied to the stator wall 37 and the orbital armatures.

In some embodiments this process may be carried out by the implementation of superconductors, wherein superconductivity can be used to create superconducting magnetic fields in the electromagnetic implementation of subsystem 14. Concerning the pair of parallel eccentric mass load subsystems 14 of the controlled translational force generating system 10 the respective directions of rotation and revolutions of the orbital frames 30 and orbital members 32 of the one subsystem 14 may be counter to the respective direction of rotation and revolutions of the orbital frame 30 and orbital members of 32 of the other subsystems 14. For instance, the orbital frame 30 of the right eccentric load mass subsystem 14 as illustrated in FIG. 4 may rotate counterclockwise about its respective central axis “C”, whereas the orbital frame 30 of the left eccentric load mass subsystem 14 as further illustrated may rotate clockwise about its respective central axis “C”. Additionally, the orbital members of the right orbital frame 30 may rotate clockwise about their respective orbital axes “0”, whereas the orbital members of the left orbital frame 30 may rotate counterclockwise about their respective orbital axes “0”. The counter-rotational relationship of the respective components of the one subsystem 14 relative to the corresponding components of the other subsystem 14 and the parallel relationship of the central rotational axes “C” of the subsystem 14 may be configured to cause a mostly straight-line orientation of the combined translational force which results from the initial translational force generated by the combined operation of the subsystems 14.

For the present disclosure, Eccentric loads masses “G,” “H,” “I,” and “J” as illustrated in FIG. 6 and FIG. 7 may display the locations of the eccentric mass loads as they rotate about the center axis of rotation distances from the center axis “E” and “F”.

FIG. 7 further illustrates an embodiment depicting an eccentric load mass diagram 400 for a four-phase generator and eccentric mass load subsystems. The diagram 400 displays the relationship between the four-phase stator wall and eccentric load masses. However, the eccentric load masses are uniquely positioned in the diagram 400, starting with a first circle 402. The first circle 402 illustrating eccentric load mass “I”, which may be positioned at a distance “E5” from the center axis of rotation “O”, while eccentric load mass “G” may be positioned at a distance “F5” from the center axis of rotation “O”. The eccentric load mass locations of “H” and “J” are also displayed in the first circle 402.

FIG. 7 further illustrates an embodiment wherein a second circle 404 depicts the eccentric load masses “H” and “I” positioned at a predefined distance “E6” from the center axis of rotation “O”, while eccentric load masses “G” and “J” are positioned at a predefined distance “F6” from the center axis of rotation “O”. A third circle 406 illustrates the eccentric load mass “H” positioned at a predefined distance “E7” from the center axis of rotation “O”, while eccentric load mass “J” is positioned at a predefined distance “F7” from the center axis of rotation “O”.

In some embodiments, a fourth circle 408 illustrates eccentric load masses “G” and “H” positioned at a predefined distance “E8” from the center axis of rotation “O”, while eccentric load masses “J” and “I” are positioned at a predefined distance “F8” from the center axis of rotation “O”.

In embodiments of the present disclosure, the four circles 402, 404, 406, and 408 illustrate a complete cycle. The cycle then repeats between the eccentric load mass diagram 300 as depicted in FIG. 6 and the eccentric load mass diagram 400 as depicted in FIG. 7. The alternating pattern of the eccentric load masses in the two diagrams 300 and 400 helps shape and maximize the resultant translational force produced by the four-phase motor and generator 100 along a selected direction, while allowing the net torque on the supporting frame to be reduced or controlled.

The four-phase motor generator 100 may be further configured to display the location of the eccentric mass loads as they revolve about their center axis of rotation. These eccentric mass loads “G,” “H,” “I,” and “J,” may comprise identical load masses, and as they revolve around the center axis of rotation other electric devices in the control panel may regulate the current to the four armatures inside the stator wall and regulate the current to the stator wall.

In some embodiments, one eccentric mass load system revolves clockwise and the other eccentric mass load system revolves counterclockwise about their respective center axes of rotation. Certain implementations may employ four armatures in a first subsystem and four armatures in a second eccentric mass load subsystem, totaling eight armatures within a pair of stator walls. By arranging the subsystems so that corresponding eccentric masses are simultaneously closest to and furthest from the center axes of rotation, the combined action of the subsystems can generate a predominantly unidirectional resultant force on the main frame 12, which may be used for controlled vibration, positioning, or load management in terrestrial or space-based platforms.

In other embodiments, an eccentric mass load system may include four eccentric mass loads revolving clockwise about a center axis of rotation and another four eccentric mass loads revolving counterclockwise about a respective center axis of rotation. By coordinating the relative phase and speed of these counter-rotating eccentric masses, the system can produce a time-varying but directionally biased pattern of forces on the supporting structure. For example, when eccentric mass loads “G,” “H,” “I,” and “J” occupy the positions corresponding to distances “E1” “E8” from the center axis of rotation “O” as shown in FIGS. 6 and 7, the resulting force components can sum to a net translational force along a selected direction while reducing undesired reaction torques. Such force patterns can be exploited in terrestrial installations or on space-based platforms for controlled vibration, positioning, or load management.

FIG. 8 illustrates an embodiment of the present disclosure, wherein timing gears 44 may be configured to rotate in opposite directions, corresponding to the counter-rotation of subsystems 14, thereby maintaining synchronization between the subsystems 14. Although FIG. 8 depicts mechanical synchronization via timing gears 44, in alternative embodiments synchronization may be achieved electromagnetically.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “four-phase generator and eccentric mass load subsystems”, “four-phase generator”, “generator”, and “generator and eccentric mass load subsystems” are interchangeable and refer to the four-phase generator and eccentric mass load subsystems 100 of the present disclosure.

Notwithstanding the forgoing, the four-phase generator and eccentric mass load subsystems 100 of the present disclosure can be of any suitable size and configuration as is known in the art without affecting the overall concept of the disclosure, provided that it accomplishes the above-stated objectives. One of ordinary skill in the art will appreciate that the four-phase generator and eccentric mass load subsystems 100, as shown in the figures is for illustrative purposes only and that many other sizes and shapes of the four-phase generator and eccentric mass load subsystems 100 are well within the scope of the present disclosure. Although the dimensions of the four-phase generator and eccentric mass load subsystems 100 are important design parameters for user convenience, the four-phase generator and eccentric mass load subsystems 100 may be of any size that ensures optimal performance during use and/or that suits the user's needs and/or preferences.

Various modifications and additions can be made to the exemplary embodiments discussed without departing from the scope of the present disclosure. While the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

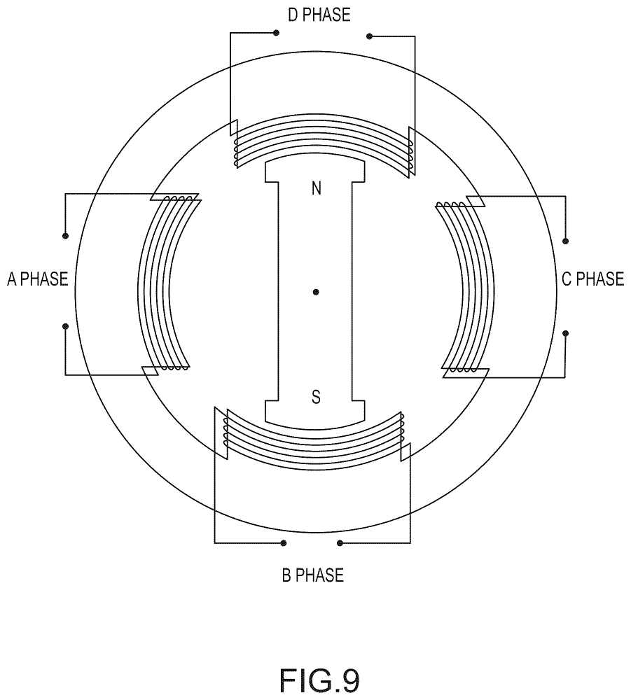

FIG. 9 illustrates a four-phase stator/armature polarity snapshot of the stator wall 102 and armature 108, showing the relative orientation of phases A-D—implemented by opposing slot pairs “A-A” (106a, 106e), “B-B” (106b, 106f), “C-C” (106c, 106g), and “D-D” (106d, 106h), with respect to the North (N) slots (106d, 106e, 106f, 106g) and South(S) slots (106a, 106b, 106c, 106h) at a representative instant in the electrical cycle.

Some embodiments illustrate a polarity snapshot of the four-phase stator wall 102 and the armature 108 at a reference instant (time interval 0), showing the instantaneous voltages of phases A-D as the armature's permanent magnet array sweeps past the opposing stator-slot pole pairs. At this instant, phase D (formed by opposing stator slots 106d and 106h) is aligned such that the North/South (“N/S”) poles of the stator wall 102 couple to the South/North poles of the armature 108 to produce a positive peak voltage in the D phase, while phase B (opposing stator slots 106b and 106f) simultaneously exhibits a negative peak voltage of equal magnitude. Phases A and C (opposing slot pairs 106a/106e and 106c/106g, respectively) are at their electrical zero crossings (null voltage). The figure therefore marks: “D PHASE—POSITIVE PEAK VOLTAGE,” “B PHASE—NEGATIVE PEAK VOLTAGE,” and “A PHASE—ZERO VOLTS,” “C PHASE—ZERO VOLTS,” with “N” and “S” indicating the instantaneous stator polarities.

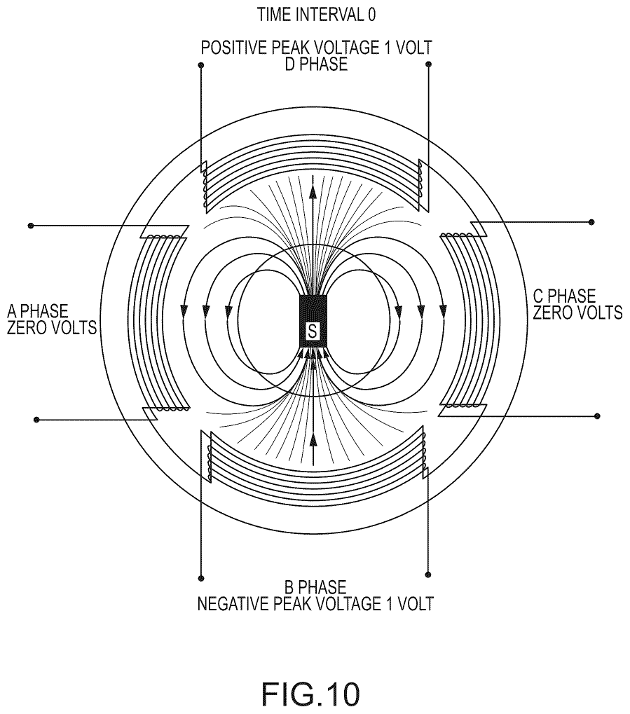

As detailed elsewhere, the four phases are realized by four opposing stator-slot pairs (“A-A,” “B-B,” “C-C,” “D-D”) arranged symmetrically around the stator wall 102 (slots-6a-106h). In preferred embodiments, the armature 108 carries four North and four South permanent magnetic poles and rotates concentrically within the stator wall 102; as the rotor field of 108 aligns with a given opposing slot pair, the corresponding phase reaches its peak, and as alignment shifts by 90 electrical degrees, that phase crosses zero. Thus, at the FIG. 9 instant, the electrical state is: D at +Vpeak, B at −Vpeak, and A and C at 0 V, consistent with the phasor relationships illustrated in FIGS. 10-18.

FIG. 10 illustrates a time-indexed operating state (time interval 0.00) in which the D-D phase (opposing stator slots 106d/106h on the stator wall 102) is at positive peak voltage, the B-B phase (opposing slots 106b/106f) is at negative peak voltage, and the A-A and C-C phases (opposing slots 106a/106e and 106c/106g) are at approximately zero volts, with all phase outputs referenced to neutral 112 and induced by the rotating armature 108.

Some embodiments depict the operating condition at time interval 0, where the D-D opposing stator slots 106d, 106h on the stator wall 102 register a positive peak voltage (+1 V) and the B-B opposing stator slots 106b, 106f simultaneously register a negative peak voltage (−1 V); at the same instant, the A-A opposing stator slots 106a, 106e and C-C opposing stator slots 106c, 106g are at approximately zero volts (null). This snapshot establishes the cycle's starting alignment for the four-phase set and corresponds to the per-phase annotations “D PHASE—POSITIVE PEAK 1 VOLT,” “B PHASE—NEGATIVE PEAK 1 VOLT,” and “A PHASE—ZERO VOLTS,” “C PHASE—ZERO VOLTS.”

In other embodiments, each phase is realized by a coil connected across the respective opposing slot pair (e.g., A-A: 106a/106e; B-B: 106b/106f; C-C: 106c/106g; D-D: 106d/106h), with returns taken to the neutral point 112. The armature 108 rotates concentrically within the stator wall 102; when the armature's permanent-magnet poles align with a given opposing slot pair, that phase reaches peak magnitude, and as alignment advances by 90 electrical degrees, the corresponding phase crosses zero. Thus, FIG. 10 shows the starting state in which the magnetic coupling between the armature 108 and the D-D pole group produces +Vpeak while the B-B pole group produces −Vpeak, with A-A and C-C at null—matching the labeling scheme used throughout the drawings.

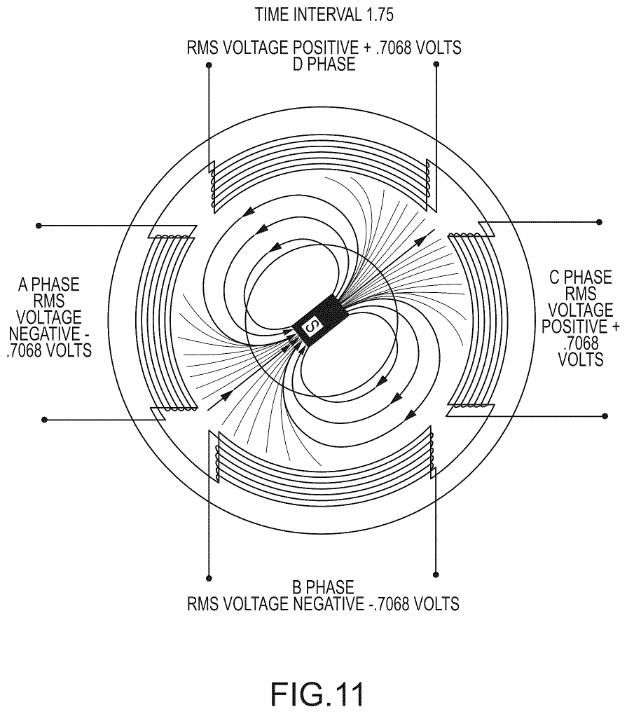

For consistency with the model used in the figure set, peak values are normalized to 1 volt (RMS≈0.7068 V for later time-indexed panels), and the sequence that follows (FIGS. 11-18) advances the peak condition among the four pole groups in 90° steps to illustrate the uniform quadrature rotation over one electrical cycle.

FIG. 11 illustrates a subsequent state (time interval 1.75) in which the instantaneous phase magnitudes are at their RMS levels (±0.7068 V for a 1 V peak model), with the D-D phase (106d/106h) and C-C phase (106c/106g) positive and the A-A phase (106a/106e) and B-B phase (106b/106f) negative, all referenced to neutral 112 on the stator wall 102 and induced by the rotating armature 108, thereby demonstrating the 90° quadrature progression.

Some embodiments show the operating condition at time interval 1.75, where each phase is at its RMS magnitude (≈±0.7068 V for a 1.0 V peak model) relative to neutral 112. At this instant the D-D phase (106d/106h) and C-C phase (106c/106g) are positive, while the A-A phase (106a/106e) and B-B phase (106b/106f) are negative. The voltages are induced by the rotating armature 108 within the stator wall 102, whose four phases are realized by the noted opposing slot pairs.

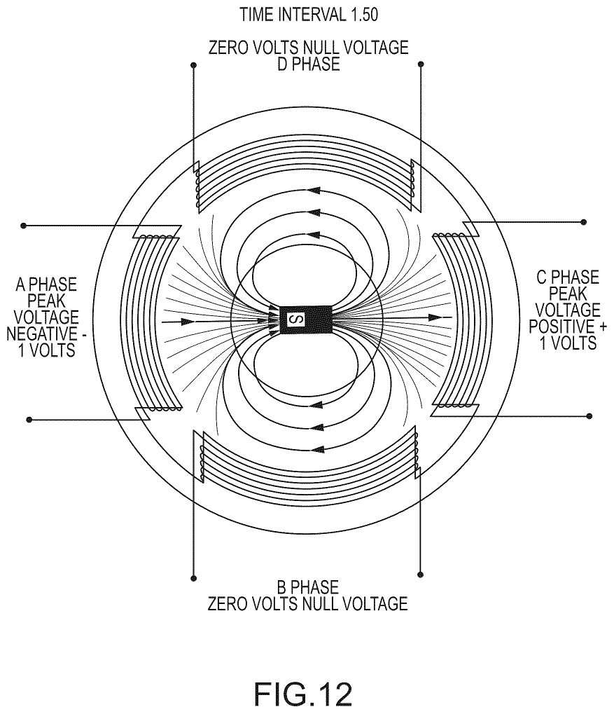

In certain embodiments, this state lies one-eighth of an electrical cycle after the peak alignment of FIG. 10 and one-eighth before the next peak in FIG. 12. Because the waveforms are sinusoidal, the RMS condition corresponds to positions where |sinθ|=1/√2, cleanly demonstrating the system's 90° quadrature progression and the alternating sign pattern among phases.

Electrically, each phase coil may span its opposing slot pair on 102; mechanically, the instantaneous N/S indications on the stator may reflect the local flux direction as the field of 108 sweeps past. Positive readings on D-D and C-C may indicate rotor-to-stator coupling in the designated positive sense for those windings, with A-A and B-B in the opposite sense.

This RMS snapshot may be used for thermal loading and power calculations for the four windings and may provide a convenient reference for phasor alignment and commutation timing between the peak panels of FIGS. 10 and 12, confirming uniform rotation and symmetry of the four-phase set realized by stator wall 102, armature 108, and neutral 112.

FIG. 12 illustrates the next quarter-cycle state (time interval 1.50) in which the C-C phase (106c/106g) reaches positive peak, the A-A phase (106a/106e) reaches negative peak, and the B-B (106b/106f) and D-D (106d/106h) phases cross near zero volts, with phase outputs taken to neutral 112 and produced by interaction of the armature 108 within the stator wall 102.

At time interval 1.50, the four-phase set may reach a quarter-cycle advance from the FIG. 10 starting state. The C-C phase (106c/106g) may be at positive peak (≈+1.0 V in the normalized model), the A-A phase (106a/106e) may be at negative peak (≈−1.0 V), and the B-B (106b/106f) and D-D (106d/106h) phases may be crossing near 0 V relative to neutral 112. This may establish the peak pair shift from the prior D/B axes to the C/A axes while maintaining the 90° spacing among all four phases.

Electromagnetically, the armature 108 (permanent-magnet rotor) may couple to the stator wall 102 such that the rotor field may align with the C-C opposing slot pair to drive maximum induced emf in the designated positive sense, while 180° out of phase the A-A pair may experience maximum induced emf in the negative sense. Simultaneously, the B-B and D-D coils may be positioned at the electrical quadrature where the net linked flux change is zero, yielding the observed zero crossings.

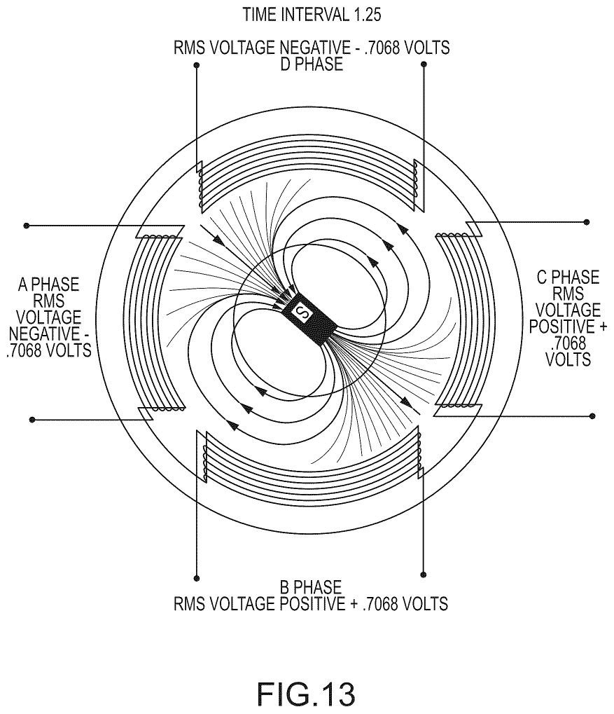

The coil topology may remain phase-to-neutral: each winding spanning its opposing slot pair (A-A: 106a/106e; B-B: 106b/106f; C-C: 106c/106g; D-D: 106d/106h) with return at 112. Read together with FIG. 11 (RMS snapshot) and FIG. 13 (subsequent RMS snapshot), FIG. 12 marks the intervening peak condition that confirms uniform quadrature rotation and symmetric progression of signs and magnitudes across the stator wall 102/armature 108 assembly.

FIG. 13 illustrates the RMS-level state (time interval 1.25) showing the C-C (106c/106g) and B-B (106b/106f) phases positive and the D-D (106d/106h) and A-A (106a/106e) phases negative at approximately ±0.7068 V (for a 1 V peak model), relative to neutral 112, further evidencing the uniform phase rotation in the machine comprising stator wall 102 and armature 108.

At time interval 1.25, each phase may be at its RMS magnitude relative to neutral 112 (≈±0.7068 V for a 1.0 V peak model). The C-C phase (106c/106g) and B-B phase (106b/106f) may be positive, while the D-D phase (106d/106h) and A-A phase (106a/106e) may be negative. The four phases may be realized by opposing slot pairs on the stator wall 102, with returns at neutral 112, and their instantaneous polarities may be induced by the rotating armature 108.

This RMS snapshot lies midway between adjacent peak states in the time-indexed sequence, capturing the condition where |sin θ|=1/√2 for each phase in a uniform 90° quadrature arrangement. The sign pattern (C, B >0; D, A <0) reflects the rotor-field advance from the prior peak alignment toward the next, confirming equal angular separation and balanced magnitude across all four windings.

Electrically, each coil may span its designated opposing slot pair, A-A (106a/106e), B-B (106b/106f), C-C (106c/106g), D-D (106d/106h), with measured voltages taken phase-to-neutral 112. Mechanically, the instantaneous N/S distribution around 102 may correspond to the local flux linkage as the armature 108 sweeps past, and may produce positive RMS readings on C-C and B-B and negative RMS readings on D-D and A-A. This state further evidences uniform phase rotation and symmetry in the stator wall 102/armature 108 machine.

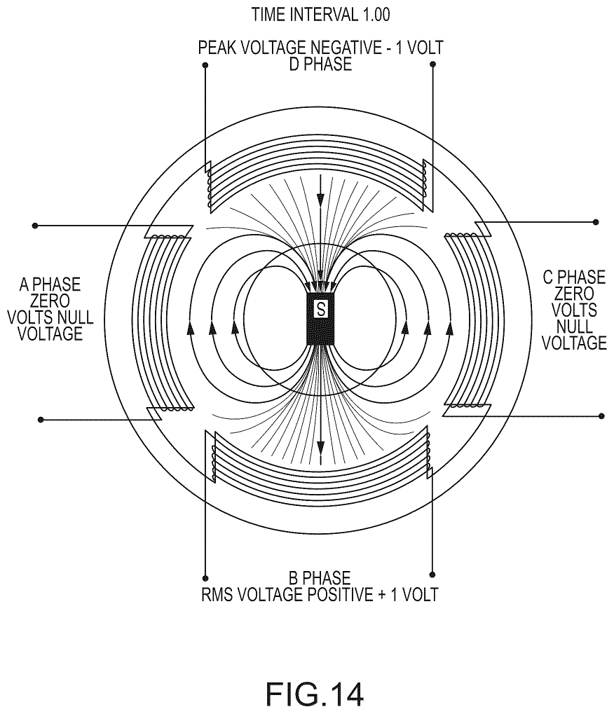

FIG. 14 illustrates the half-cycle state (time interval 1.00) in which the B-B phase (106b/106f) is at positive peak and the D-D phase (106d/106h) is at negative peak while the A-A (106a/106e) and C-C (106c/106g) phases are near zero volts, with all phase outputs referenced to neutral 112 on the stator wall 102 and driven by the rotating armature 108.

At time interval 1.00, one half-cycle from the FIG. 10 starting state, the B-B phase (106b/106f) may be at positive peak (≈+1.0 V in the normalized model) and the D-D phase (106d/106h) is at negative peak (≈−1.0 V), while the A-A (106a/106e) and C-C (106c/106g) phases are near 0 V relative to neutral 112. This arrangement is the 180° complement of the initial D/B peak pair, confirming half-cycle symmetry in the four-phase set on the stator wall 102 driven by the rotating armature 108.

Electromagnetically, the armature 108 field may align with the B-B opposing slot pair to maximize induced emf in the designated positive sense, while the diametrically opposed D-D pair may experience maximum induced emf in the negative sense. The A-A and C-C coils may lie at the quadrature positions where net linked flux change may be momentarily zero, yielding the observed zero crossings. Instantaneous N/S indications around 102 may reflect this flux distribution as the rotor field sweeps past.

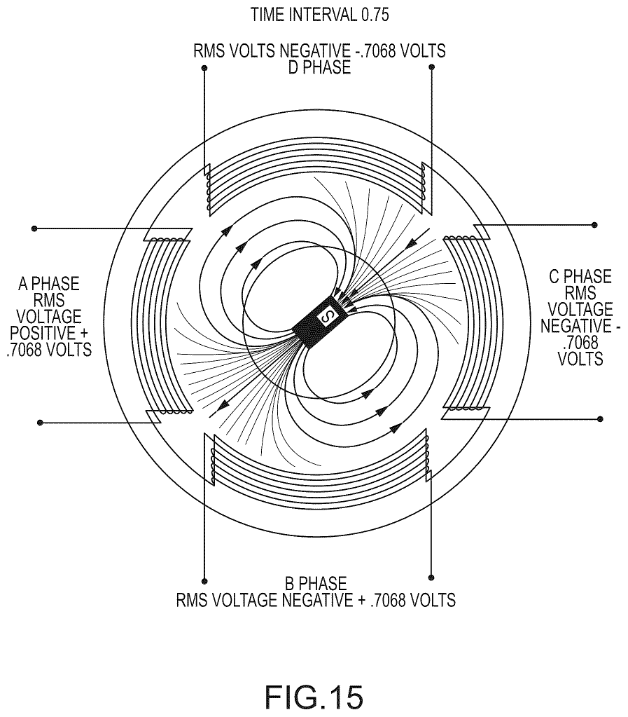

Each winding spans its opposing slot pair, A-A (106a/106e), B-B (106b/106f), C-C (106c/106g), D-D (106d/106h), with measured voltages phase-to-neutral 112. Practically, this half-cycle peak state may be a convenient commutation reference: it validates uniform 90° spacing, provides a midpoint check on phasor rotation between FIGS. 13 and 15, and is useful for control strategies that target minimal torque ripple and predictable thermal loading across the four windings.

FIG. 15 illustrates the RMS-level state (time interval 0.75) in which the A-A phase (106a/106e) is positive (≈+0.7068 V), the C-C phase (106c/106g) is negative (≈−0.7068 V), and the B-B (106b/106f) and D-D (106d/106h) phases are shown at RMS magnitude as annotated (≈±0.7068 V), all relative to neutral 112, reflecting the quarter-cycle offset among all four phases within the stator wall 102/armature 108 assembly.

At time interval 0.75, each phase may be at its RMS magnitude relative to neutral 112 (≈±0.7068 V for a 1.0 V peak model). The A-A phase (106a/106e) may be positive (≈+0.7068 V), the C-C phase (106c/106g) may be negative (≈−0.7068 V), and the B-B (106b/106f) and D-D (106d/106h) phases may be at RMS magnitude as annotated (≈±0.7068 V). Voltages may be measured phase-to-neutral 112 for windings distributed on the stator wall 102 and excited by the rotating armature 108.

Electromagnetically, this RMS snapshot may represent a quarter-cycle offset from the adjacent peak states: the rotor field of armature 108 links the A-A coil in the positive sense and the C-C coil in the negative sense, while B-B and D-D sit at the same |sin θ|=1/√2 magnitude in their respective instantaneous polarities. The arrangement may preserve the uniform 90° quadrature among phases A-A (106a/106e), B-B (106b/106f), C-C (106c/106g), and D-D (106d/106h) around the stator wall 102, with the instantaneous N/S indications reflecting local flux direction as the field sweeps past.

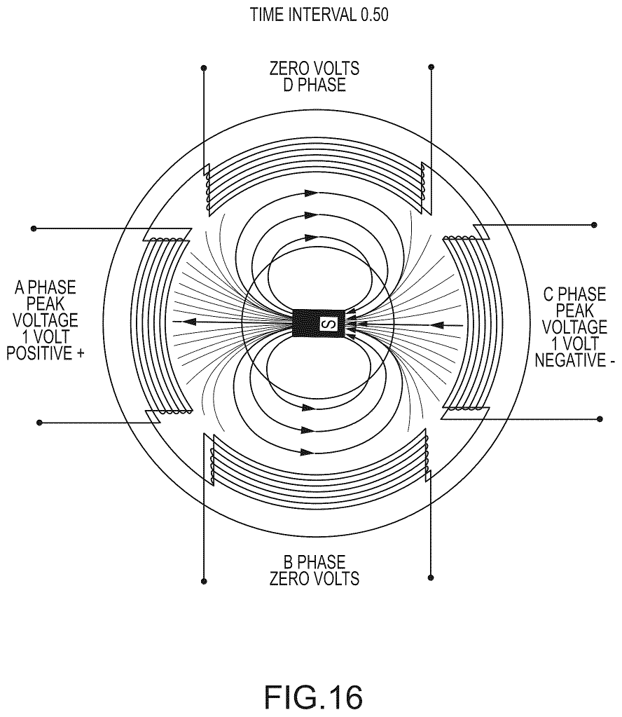

Practically, the FIG. 15 condition may be useful for thermal and power calculations because RMS values map directly to copper heating in each winding. As a timing reference between the peak panels (FIGS. 14 and 16), it confirms balanced magnitudes and alternating polarities across the four coils, supporting control strategies that rely on predictable phasor alignment and low torque ripple in the stator wall 102/armature 108 assembly.

FIG. 16 illustrates the quarter-cycle state (time interval 0.50) in which the A-A phase (106a/106e) reaches positive peak and the C-C phase (106c/106g) reaches negative peak while the B-B (106b/106f) and D-D (106d/106h) phases cross near zero volts, the voltages being measured to neutral 112 and induced by rotation of the armature 108 within the stator wall 102.

At time interval 0.50, the four-phase set may be advanced by a quarter cycle from the FIG. 14 half-cycle state. The A-A phase (106a/106e) may be at positive peak (≈+1.0 V in the normalized model), the C-C phase (106c/106g) may be at negative peak (≈−1.0 V), and the B-B (106b/106f) and D-D (106d/106h) phases may be crossing near 0 V, with all measurements taken phase-to-neutral 112. This peak pairing (A/C) reflects the uniform 90° rotation of the waveform set around the stator wall 102.

Electromagnetically, the permanent-magnet armature 108 is oriented so its field maximizes flux linkage through the A-A opposing slot pair in the designated positive sense, while the diametrically opposed C-C pair experiences maximum linkage in the negative sense. At the same instant, the B-B and D-D coils lie at electrical quadrature where the net time rate of change of linked flux is zero, yielding their zero-crossings. Instantaneous N/S markings on 102 correspond to the local stator polarity distribution produced by the sweeping field of 108.

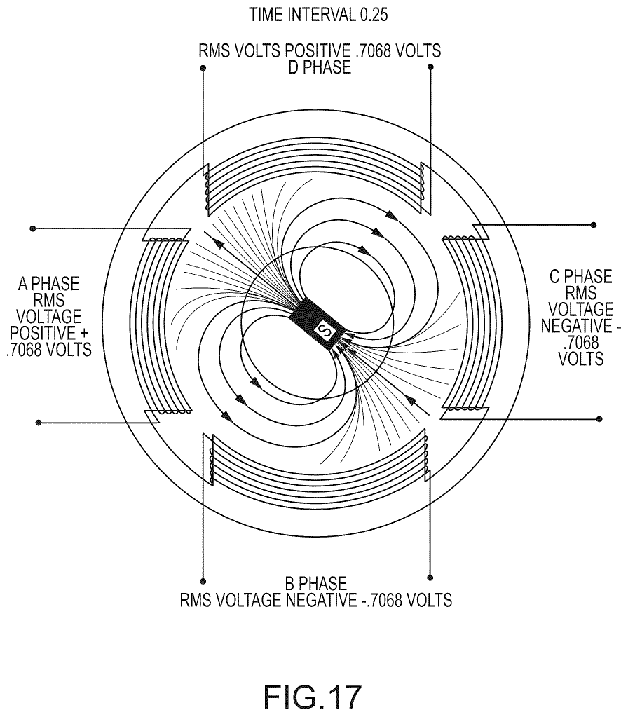

Each phase winding spans its opposing slot pair, A-A (106a/106e), B-B (106b/106f), C-C (106c/106g), D-D (106d/106h), with returns at neutral 112. Read together with the preceding RMS snapshot (FIG. 15) and the following RMS snapshot (FIG. 17), FIG. 16 provides the intervening peak condition that confirms balanced magnitudes, alternating signs, and consistent quadrature progression within the stator wall 102/armature 108 assembly.

FIG. 17 illustrates the RMS-level state (time interval 0.25) in which the A-A (106a/106e) and D-D (106d/106h) phases are positive and the B-B (106b/106f) and C-C (106c/106g) phases are negative at approximately ±0.7068 V (for a 1 V peak model), all referenced to neutral 112, demonstrating uniform phase symmetry across the stator wall 102/armature 108 system.

At time interval 0.25, each phase may be at its RMS magnitude relative to neutral 112 (≈±0.7068 V for a 1.0 V peak model). The A-A (106a/106e) and D-D (106d/106h) phases may be positive, while the B-B (106b/106f) and C-C (106c/106g) phases may be negative. Voltages are measured phase-to-neutral 112 for windings distributed on the stator wall 102 and excited by the rotating armature 108.

Electromagnetically, this RMS snapshot falls midway between adjacent peak states: the rotor field of armature 108 links the A-A and D-D coils in the positive sense and the B-B and C-C coils in the negative sense, with all four at |sin θ|=1/√2. The arrangement preserves uniform 90°quadrature among phases A-A (106a/106e), B-B (106b/106f), C-C (106c/106g), and D-D (106d/106h), and the instantaneous N/S indications around 102 reflect the local flux direction as the field sweeps past.

Practically, the FIG. 17 condition confirms phase symmetry and balance immediately before the subsequent peak panel, providing a convenient reference for phasor alignment, commutation timing, and thermal/power calculations based on RMS values in the stator wall 102/armature 108 system.

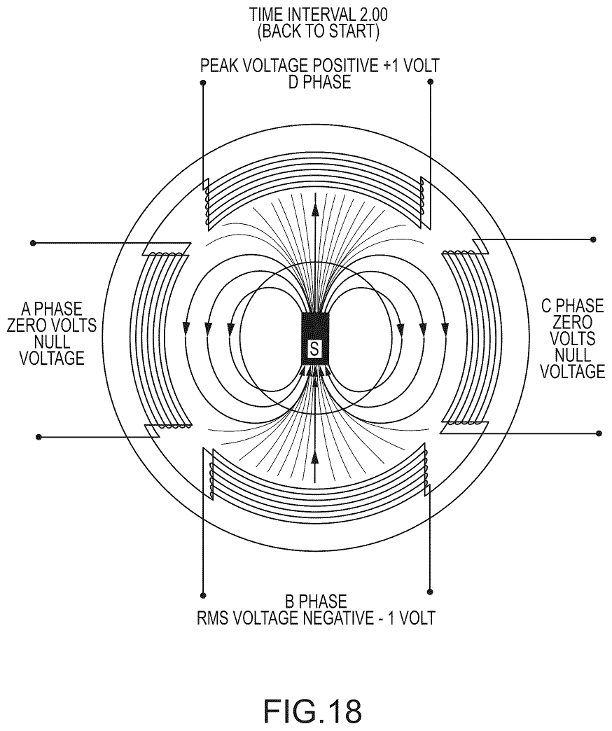

FIG. 18 illustrates the full-cycle return (time interval 2.00) at which the D-D phase (106d/106h) again reaches positive peak, the B-B phase (106b/106f) reaches negative peak, and the A-A (106a/106e) and C-C (106c/106g) phases cross near zero volts, with outputs referenced to neutral 112, thereby bringing the sequence back to the starting condition in the stator wall 102/armature 108 configuration.

At time interval 2.00, the system returns to the initial alignment of one full electrical cycle earlier. The D-D phase (106d/106h) may be at positive peak (≈+1.0 V in the normalized model), the B-B phase (106b/106f) may be at negative peak (≈−1.0 V), and the A-A (106a/106e) and C-C (106c/106g) phases may be near 0 V, with all measurements taken phase-to-neutral 112. This state reproduces the starting condition of the four-phase set on the stator wall 102, confirming full-cycle periodicity under excitation from the rotating armature 108.

Electromagnetically, the permanent-magnet field of armature 108 maximizes flux linkage through the D-D opposing slot pair in the designated positive sense while driving maximum negative linkage through the diametrically opposed B-B pair; A-A and C-C occupy the quadrature positions where the time rate of change of linked flux is zero, yielding their zero-crossings. Instantaneous N/S markings around 102 mirror this local polarity distribution as the rotor field completes its revolution.

Each phase winding spans its opposing slot pair, A-A (106a/106e), B-B (106b/106f), C-C (106c/106g), D-D (106d/106h), with returns at neutral 112. By closing the loop back to the FIG. 10 starting state, FIG. 18 verifies uniform 90° quadrature, balanced magnitudes and signs, and provides a convenient commutation/reference point for control and validation of the stator wall 102/armature 108 configuration.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A four-phase motor and generator device comprising:
a stator wall having eight stator slots disposed therein, the eight stator slots being arranged as four pole groups, each pole group comprising a pair of opposing stator slots, wherein one stator slot of each pair of opposing stator slots is configured to operate as a North-polarity stator slot and the other stator slot of the pair is configured to operate as a South-polarity stator slot;
an armature positioned within the stator wall, the armature comprising permanent magnetic material arranged to provide four North poles and four South poles disposed alternately around the armature; and
a plurality of coils, each coil being magnetically coupled to a corresponding one of the four pole groups and electrically connected between the opposing stator slots of the corresponding pole group and a neutral point,
wherein rotation of the armature relative to the stator wall induces four phase-to-neutral alternating voltages in the coils that are mutually phase-shifted by approximately ninety electrical degrees so that all eight stator poles are actively magnetically coupled over an electrical cycle to generate electrical energy.

2. The four-phase motor and generator device of claim 1, further comprising a direct-current motor mechanically coupled to the armature and a battery system configured to supply direct current to the direct-current motor, wherein, when the armature is mechanically driven by the direct-current motor, the coils generate four-phase alternating current voltages.

3. The four-phase motor and generator device of claim 2, further comprising a control panel electrically coupled to the coils and to the battery system and configured to:
(a) in a generator mode, receive the four-phase alternating current voltages generated by the coils and regulate charging of the battery system; and
(b) in a motor mode, supply electrical current derived from the battery system to at least some of the coils so that the device operates as a four-phase motor.

4. The four-phase motor and generator device of claim 1, further comprising a control panel including power-electronic circuitry configured to:
rectify at least a subset of the four-phase alternating current voltages from the coils to produce one or more direct-current output buses; and
regulate current flow between the coils, a battery system, and at least one external power source.

5. The four-phase motor and generator device of claim 1, wherein each coil has a pair of slot terminals associated with the corresponding pair of opposing stator slots, and the device provides eight neutral-referenced alternating current output terminals respectively corresponding to the eight stator slots.

6. The four-phase motor and generator device of claim 4, further comprising a solar panel system and at least one voltage regulator configured to convert output of the solar panel system into regulated direct current supplied to the control panel and the battery system, the control panel being further configured to coordinate power sharing between the solar panel system and the four-phase alternating current generated by the coils.

7. The four-phase motor and generator device of claim 1, further comprising at least one eccentric mass load subsystem mechanically coupled to the armature and a pair of timing gears configured to counter-rotate respective eccentric mass load subsystems so as to synchronize phase relationships between eccentric mass loads driven by four-phase alternating current supplied by the device.

8. The four-phase motor and generator device of claim 1, wherein the device is configured for use on a spacecraft, satellite, or other space-based platform to provide four-phase alternating current and rectified direct-current power for at least one of: reaction-wheel or momentum-exchange assemblies, attitude control, payload repositioning, vibration management, debris handling, or resource transport operations in a low-gravity or microgravity environment.

9. The four-phase motor and generator device of claim 5, wherein the coils and the neutral point are configured such that an instantaneous sum of phase currents associated with the four pole groups is substantially zero, thereby forming a balanced four-phase star connection that reduces ripple in direct-current voltages obtained by rectifying the eight output terminals.

10. The four-phase motor and generator device of claim 5, wherein each pair of opposing stator slots is coupled to a corresponding rectifier circuit so that slot-level rectified direct-current voltages derived from the eight alternating current output terminals exhibit reduced ripple relative to rectified output of a three-phase generator having a comparable rating.

11. A method of operating a four-phase motor and generator device, the method comprising:
rotating an armature having four North poles and four South poles within a stator wall comprising eight stator slots arranged as four pole groups, each pole group comprising a pair of opposing stator slots;
magnetically coupling the North poles and South poles of the armature to the stator slots so as to induce, in coils connected between the opposing stator slots and a neutral point, four phase-to-neutral alternating voltages that are mutually phase-shifted by approximately ninety electrical degrees;
generating electrical energy by taking alternating current outputs from slot terminals associated with the coils; and
processing the alternating current outputs to provide at least one regulated direct-current output that supplies current to a battery system, while at least one supplementary electricity-generating source provides additional current for recharging the battery system.

12. The method of claim 11, further comprising rectifying alternating current voltages from eight stator-slot terminals individually to obtain slot-level direct-current voltages and summing at least a subset of the slot-level direct-current voltages to reduce ripple in the direct-current output supplied to the battery system.

13. The method of claim 11, further comprising operating the four-phase motor and generator device in a motor mode by supplying controlled alternating or rectified currents from the battery system or from an external power source to at least some of the coils to produce torque on the armature.

14. The method of claim 11, further comprising controlling at least one of a rotational speed of the armature and a load applied to the alternating current outputs so as to regulate at least one of an electrical frequency, a peak amplitude, and an RMS amplitude of the four phase-to-neutral alternating voltages generated by the coils.

15. A method of rotating eccentric load masses using a four-phase motor and generator device, the method comprising:
providing a four-phase motor and generator device having a stator wall with eight stator slots arranged as four pole groups of opposing stator slots, an armature positioned within the stator wall, and coils connected between opposing stator slots and a neutral point to generate four-phase alternating current;
mechanically coupling a plurality of eccentric load masses to at least one shaft driven by the four-phase motor and generator device so that the eccentric load masses rotate about a center axis of rotation;
energizing the coils with four-phase alternating current so that the armature rotates relative to the stator wall and drives the shaft;
sequentially positioning the eccentric load masses at different angular locations and radial offset distances from the center axis of rotation during a revolution; and
selecting the angular locations and radial offset distances so that a resultant translational force vector produced by the rotating eccentric load masses has a desired magnitude and direction relative to a supporting frame.

16. The method of claim 15, further comprising providing first and second eccentric mass load subsystems each including a plurality of eccentric load masses rotating about respective parallel center axes of rotation, and counter-rotating the first and second eccentric mass load subsystems so that torques produced by the respective subsystems at least partially cancel while the resultant translational force on the supporting frame remains predominantly in a selected direction.

17. The method of claim 15, wherein sequentially positioning the eccentric load masses at different radial offset distances comprises moving each eccentric load mass through a sequence of positions corresponding to different distances from the center axis of rotation in accordance with an eccentric load mass diagram that alternates between first and second sets of radial distances so as to shape and maximize the resultant translational force.

18. A method of rotating eccentric load masses in a four-phase motor and generator device, the method comprising:
providing a four-phase motor and generator device having a stator wall, an armature, and four eccentric load masses configured to rotate about a common center axis of rotation;
energizing coils associated with the stator wall with four-phase alternating current so that the armature rotates and drives rotation of the eccentric load masses;
moving sequentially each of the four eccentric load masses through a first angular position having a first offset distance from the center axis of rotation, a second angular position having a second offset distance from the center axis of rotation, a third angular position having a third offset distance from the center axis of rotation, and a fourth angular position having a fourth offset distance from the center axis of rotation;
selecting the offset distances such that the second offset distance is less than the first offset distance, the third offset distance is approximately equal to the first offset distance, and the fourth offset distance is less than the third offset distance; and
repeatedly cycling the eccentric load masses through the first, second, third, and fourth angular positions in synchronism with the four-phase alternating current so as to generate a predominantly unidirectional translational force.

19. A controlled translational force generation system comprising:
at least one four-phase motor and generator device according to claim 1 configured to generate four-phase alternating current and rectified direct-current power;
a plurality of eccentric mass loads configured to rotate about at least one center axis of rotation;
a synchronization mechanism configured to coordinate counter-rotation of first and second eccentric mass load subsystems, the synchronization mechanism comprising timing gears mechanically coupled to the eccentric mass load subsystems; and
a control panel configured to regulate current between the four-phase motor and generator device, one or more batteries, at least one electrical energy input, and at least one motor that drives the eccentric mass loads,
wherein coordinated rotation of the eccentric mass loads produces a translational force that has a predominant direction relative to a main frame of the system.

20. The controlled translational force generation system of claim 19, further comprising a solar panel distribution arrangement configured to provide regulated direct-current power to the control panel and the one or more batteries, the control panel being further configured to selectively route four-phase alternating current from the four-phase motor and generator device and direct current from the solar panel distribution arrangement to the at least one motor that drives the eccentric mass loads.
